(19) United States
(12) Patent Application Publication
(10) Pub. No.: US 2026/0273870 A1
(43) Pub. Date: Sep. 17, 2026

(54) METHOD FOR MANUFACTURING PRESSURE VESSEL CONFIGURED TO STORE FLUID

(71) Applicant: TOYOTA JIDOSHA KABUSHIKI KAISHA, Toyota-shi (JP)

(72) Inventor: Akiyoshi FURUZAWA, Toyota-shi (JP)

(73) Assignee: TOYOTA JIDOSHA KABUSHIKI KAISHA, Toyota-shi (JP)

(21) Appl. No.: 19/381,684

(22) Filed: Nov. 6, 2025

(30) Foreign Application Priority Data
Mar. 11, 2025 (JP) 2025-038428

(51) Int. Cl. B29C 70/34; B29C 70/32; B29K 307/04; B29L 31/00; F17C 1/06

(52) U.S. Cl. CPC B29C 70/347; B29C 70/32; F17C 1/06; B29K 2307/04; B29L 2031/7156; F17C 2201/0109; F17C 2203/012; F17C 2203/0619; F17C 2209/2154; F17C 2209/232; F17C 2221/012; F17C 2270/0168; F17C 2270/0184

(57) ABSTRACT

The pressure vessel may include a laminated structure comprising a liner layer and a reinforcement layer that are laminated on each another, and a shape of the pressure vessel includes a cylindrical portion extending along an axial direction, and dome portions respectively disposed at opposing ends of the cylindrical portion in the axial direction. A method for manufacturing the pressure vessel may include: applying a compressive force along the axial direction to a semi-finished product of the pressure vessel comprising the liner layer; forming the reinforcement layer onto an outer surface of the semi-finished product with the compressive force applied thereon, with a reinforced fiber impregnated with a curable resin; and curing the resin by heating the semi-finished product comprising the formed reinforcement layer.

### REFERENCE TO RELATED APPLICATION

This application claims priority from Japanese Patent Application No. 2025-038428 filed on Mar. 11, 2025. The entire content of the priority application is incorporated herein by reference.

### TECHNICAL FIELD

The art disclosed herein relates to a method for manufacturing a pressure vessel configured to store a fluid.

### BACKGROUND ART

A method for manufacturing a pressure vessel configured to store a fluid is disclosed in Japanese Patent Application Publication No. 2015-157449. The pressure vessel of Japanese Patent Application Publication No. 2015-157449 has a laminated structure including a liner layer and a reinforcement layer. The shape of this pressure vessel has a cylindrical portion extending along an axial direction and dome portions respectively disposed at opposing ends of the cylindrical portion in the axial direction. The above manufacturing method has a step of forming the reinforcement layer onto an outer surface of a semi-finished product with reinforced fibers impregnated with a curable resin (resin before being cured).

### SUMMARY

Generally, a manufacturing method for a pressure vessel includes a step of curing a resin by heating a semi-finished product on which a reinforcement layer is formed. The heat in this step softens the liner layer. The softening of the liner layer may cause the liner layer to deform inwardly. The deformation of the liner layer creates a gap between the reinforcement layer and the liner layer. The gap between the reinforcement layer and the liner layer can reduce the strength of the pressure vessel.

This specification provides a technology that can improve the strength of a pressure vessel.

In a first aspect of the present technology, a method for manufacturing a pressure vessel configured to store a fluid is disclosed. The pressure vessel may comprise a laminated structure comprising a liner layer and a reinforcement layer that are laminated on each another. A shape of the pressure vessel may include a cylindrical portion extending along an axial direction and dome portions respectively disposed at opposing ends of the cylindrical portion in the axial direction. The method may comprise: applying a compressive force along the axial direction to a semi-finished product of the pressure vessel comprising the liner layer; forming the reinforcement layer onto an outer surface of the semi-finished product with the compressive force applied thereon, with a reinforced fiber impregnated with a curable resin; and curing the resin by heating the semi-finished product comprising the formed reinforcement layer.

According to the above configuration, at the start of the resin curing, the semi-finished product is loaded with the compressive force. That is, a distortion is occurring in the liner layer of the semi-finished product. According to this configuration, even if the liner layer softens during the resin curing, inward deformation of the liner layer is suppressed. Therefore, generation of a gap between the liner layer and the reinforcement layer in the pressure vessel can be suppressed. Therefore, the strength of the pressure vessel can be improved.

### BRIEF DESCRIPTION OF DRAWINGS

FIG. 1 is a cross-sectional view of a pressure vessel 2.

FIG. 2 shows a semi-finished product 40 in the state of being installed in a manufacturing device 50.

FIG. 3 shows steps in a manufacturing process of the pressure vessel 2.

FIG. 4 shows the shape of a shoulder portion before and after a compression step.

FIG. 5 shows the shape of a shoulder portion before and after a heat treatment step in a comparative example.

### DESCRIPTION

In a first aspect in the present technology, a method for manufacturing a pressure vessel configured to store a fluid is disclosed. The pressure vessel may comprise a laminated structure comprising a liner layer and a reinforcement layer that are laminated on each another. A shape of the pressure vessel may include a cylindrical portion extending along an axial direction, and dome portions respectively disposed at opposing ends of the cylindrical portion in the axial direction. The method may comprise: applying a compressive force along the axial direction to a semi-finished product of the pressure vessel comprising the liner layer; forming the reinforcement layer onto an outer surface of the semi-finished product with the compressive force applied thereon, with a reinforced fiber impregnated with a curable resin; and curing the resin by heating the semi-finished product comprising the formed reinforcement layer.

In a second aspect, in the first aspect, in the applying of the compressive force, the compressive force may be applied so that the liner layer at shoulder portions is displaced outward in a radial direction, wherein the shoulder portions are respectively located at boundaries between the cylindrical portion and the dome portions.

According to the above configuration, it is possible to suppress the formation of a gap between the liner layer and the reinforcement layer at the shoulder portions of the pressure vessel. Therefore, the reinforcement layer can firmly reinforce the liner layer.

In a third aspect, in the first or second aspect, the applying of the compressive force may comprise: supporting the opposing ends in the axial direction of the semi-finished product; and bringing at least one end of the supported ends closer to another end of the supported ends.

According to the above configuration, the compressive force can be applied to the semi-finished product with a simple configuration.

In a fourth aspect, in any one of the first to third aspects, in the forming of the reinforcement layer, the reinforcement layer may be formed by a filament winding method.

### Embodiment

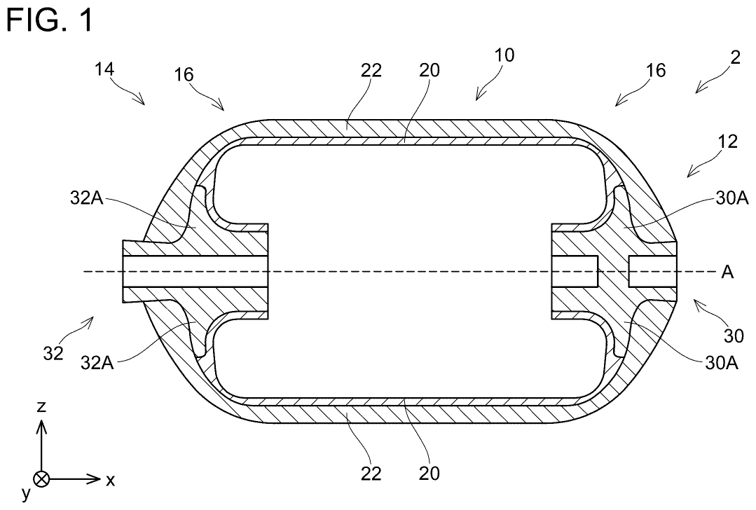

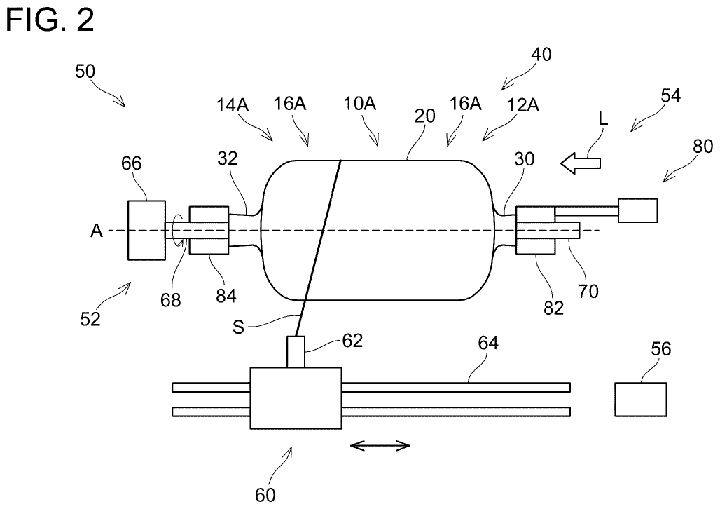

Referring to FIGS. 1 and 2, a pressure vessel 2 configured to store a fluid is described. In one example, the pressure vessel 2 is mounted on a fuel cell vehicle (not shown). The pressure vessel 2 is filled with high-pressure hydrogen gas that is used to generate electricity for a fuel cell vehicle. The pressure vessel 2 is a so-called hydrogen tank.

As shown in FIG. 1, the shape of the pressure vessel 2 has a cylindrical portion 10, a first dome portion 12, and a second dome portion 14. In the following, the axial direction of the cylindrical portion 10 and the radial direction of the cylindrical portion 10 are simply described as “axial direction” and “radial direction”, respectively. The axial direction is along a central axis A of the cylindrical portion 10. One side in the axial direction and the other side in the axial direction are described as “one side in the axial direction” and “the other side in the axial direction”, respectively, in the following. The one side in the axial direction and the other side in the axial direction are the right side and the left side of FIG. 1, respectively.

The first dome portion 12 is arranged at one end of the cylindrical portion 10 in the axial direction. The second dome portion 14 is arranged at the other end of the cylindrical portion 10 in the axial direction. The first dome portion 12 and the second dome portion 14 have a hemispherical shape that bulges outwardly along the axial direction from the cylindrical portion 10. In the following, the boundary between the cylindrical portion 10 and the first dome portion 12 and the boundary between the cylindrical portion 10 and the second dome portion 14 are described as “shoulder portions 16”. The pressure vessel 2 has a structure in which the liner layer 20 and the reinforcement layer 22 are laminated. In one example, the liner layer 20 is made of resin. The reinforcement layer 22 covers the outer surface of the liner layer 20 to reinforce the liner layer 20. The reinforcement layer 22 is made of a known fiber-reinforced resin. In one example, the reinforcement layer 22 is made of Carbon Fiber Reinforced Plastics (CFRP).

The pressure vessel 2 further comprises a first mouthpiece 30 and a second mouthpiece 32. The first mouthpiece 30 is arranged in the first dome portion 12. The second mouthpiece 32 is arranged in the second dome portion 14. The first mouthpiece 30 and the second mouthpiece 32 cover the outer surface of the liner layer 20. In one example, the first mouthpiece 30 and the second mouthpiece 32 are joined to the liner layer 20 by insert molding and adhesion. In the axial direction, a flange 30A of the first mouthpiece 30 and a flange 32A of the second mouthpiece 32 are located between the liner layer 20 and the reinforcement layer 22. A valve or the like is attached to each of the first mouthpiece 30 and the second mouthpiece 32. The first mouthpiece 30 and the second mouthpiece 32 also function as members for rotatably holding the pressure vessel 2 in the process of forming the reinforcement layer 22.

### Configuration of Manufacturing Device 50

Referring to FIG. 2, a manufacturing device 50 used for manufacturing the pressure vessel 2 will be described. The manufacturing device 50 winds a reinforced fiber S around the outer surface of a semi-finished product 40. The semi-finished product 40 includes a cylindrical portion 10A, a first dome portion 12A, a second dome portion 14A, a shoulder portion 16A, the first mouthpiece 30, and the second mouthpiece 32. The cylindrical portion 10A, the first dome portion 12A, and the second dome portion 14A are composed of the liner layer 20.

The manufacturing device 50 comprises a winding unit 52, a compression unit 54, and a controller 56. The winding unit 52 is a so-called filament winding device. In the following, filament winding is described as “FW”. The winding unit 52 has a housing section 60, a supply port 62, a pair of rails 64, a motor 66, a rotation shaft 68, and a support shaft 70. The housing section 60 contains a bobbin of the reinforced fiber S impregnated with a curable resin (resin before being cured). The supply port 62 is connected to the housing section 60. The supply port 62 feeds the reinforced fiber S in the housing section 60 toward the semi-finished product 40. The pair of rails 64 extends along the axial direction. The housing section 60 is disposed on the pair of rails 64. An actuator (not shown) is connected to the housing section 60. The housing section 60 is movable on the pair of rails 64.

The rotation shaft 68 is connected to the motor 66. The rotation shaft 68 is fixed to the second mouthpiece 32 of the semi-finished product 40. The support shaft 70 rotatably supports the first mouthpiece 30 of the semi-finished product 40. When the motor 66 is driven, the rotation shaft 68 rotates. The semi-finished product 40 rotates in response to the rotation of the rotation shaft 68.

The compression unit 54 includes an actuator 80, a movable plate 82, and a fixed plate 84. The fixed plate 84 is fixed to the rotation shaft 68 in a rotatable manner. The movable plate 82 is attached to the support shaft 70. The movable plate 82 is movable with respect to the support shaft 70. The actuator 80 is connected to the movable plate 82. The actuator 80 moves the movable plate 82 along the axial direction.

The controller 56 is a computer composed of a CPU, ROM, RAM, etc. The controller 56 controls the operation of each component of the manufacturing device 50.

### Method for Manufacturing Pressure Vessel 2

Referring to FIGS. 2 to 4, a manufacturing method of the pressure vessel 2 will be described.

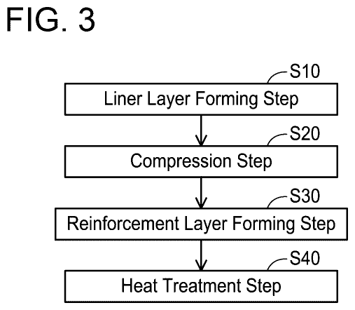

In S10 of FIG. 3, the semi-finished product 40 (see FIG. 2) is formed (liner layer forming step). As an example, in the liner layer forming step, one half of the liner layer 20 in the axial direction and the other half of the liner layer 20 in the axial direction are welded together. The first mouthpiece 30 and the second mouthpiece 32 are then joined to the liner layer 20.

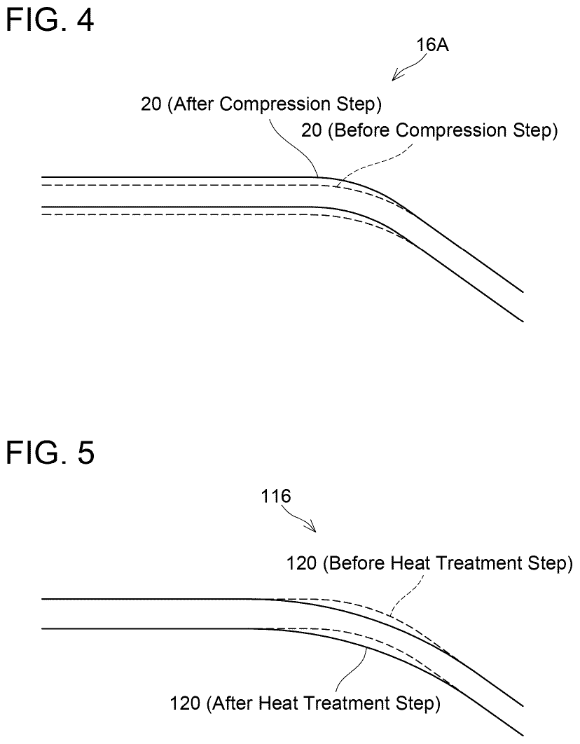

In S20, a compressive force L along the axial direction is applied to the semi-finished product 40 using the manufacturing device 50 (compression step). The compression step is explained with reference to FIGS. 2 and 4.

The compression step includes a support process and an approaching process. As shown in FIG. 2, in the support process, the first mouthpiece 30 of the semi-finished product 40 is attached to the support shaft 70 of the manufacturing device 50, and the second mouthpiece 32 of the semi-finished product 40 is attached to the rotation shaft 68 of the manufacturing device 50. As a result, opposing ends (both ends) of the semi-finished product 40 in the axial direction are supported by the manufacturing device 50. In this state, the fixed plate 84 of the manufacturing device 50 is in contact with the second mouthpiece 32.

Next, in the approaching process, the actuator 80 is driven by the controller 56. As a result, the movable plate 82 of the manufacturing device 50 moves from one side in the axial direction to the other side in the axial direction. That is, the end on the one side in the axial direction of the semi-finished product 40 is brought closer to the end on the other side in the axial direction of the semi-finished product 40. As a result, the compressive force L is applied to the semi-finished product 40.

Referring to FIG. 4, the semi-finished product 40 before the compressive force L is applied and the semi-finished product 40 after the compressive force L has been applied are described. FIG. 4 is an enlarged view of the area near the shoulder portion 16A on the one side of the semi-finished product 40 in the axial direction. In FIG. 4, the liner layer 20 before the compression step is shown by a dashed line, and the liner layer 20 after the compression step is shown by a solid line.

As shown in FIG. 4, the compressive force L causes distortion in the shoulder portion 16A of the semi-finished product 40 to which the compressive force L is applied, in detail, in the liner layer 20. Specifically, the liner layer 20 in the shoulder portion 16A is displaced outward (e.g., in upper right direction in FIG. 4) relative to the liner layer 20 before the compression step. More specifically, the liner layer 20 after the compression step is displaced outward in the radial direction relative to the liner layer 20 before the compression step.

Next, in S30 of FIG. 3, the reinforced fiber S impregnated with a curable resin is wound around the outer surface of the semi-finished product 40 with the compressive force L applied thereon (reinforcement layer forming step). In the reinforcement layer forming step, the controller 56 drives the motor 66 and the actuator connected to the housing section 60. In this embodiment, the reinforced fiber S is wound around the outer surface of the semi-finished product 40 using the known FW method. In one example, the reinforced fiber S is wound around the outer surface of the semi-finished product 40 by hoop winding and helical winding of the FW method. As a result, the reinforcement layer 22 is formed on the outer surface of the semi-finished product 40. This reinforcement layer 22 keeps the liner layer 20 compressed in the axial direction. In a variation, the reinforced fiber S may be wound around the outer surface of the semi-finished product 40 by only helical winding in the FW method.

In S40, the semi-finished product 40 in which the reinforcement layer 22 is formed is heated using a heat treatment device different from the manufacturing device 50 (heat treatment step). By heating the semi-finished product 40, the resin impregnated in the reinforcement layer 22 cures. This completes the pressure vessel 2 shown in FIG. 1. The shape of the liner layer 20 in the shoulder portions 16 of the pressure vessel 2 is approximately the same as the shape of the liner layer 20 (solid line portion in FIG. 4) after the compression step.

### Effect of Present Embodiment

Before explaining the effect of the manufacturing method of the pressure vessel 2 in this embodiment, a pressure vessel manufactured by a manufacturing method of a pressure vessel in a comparative example is explained. The manufacturing method in the comparative example is the same as the manufacturing method in this embodiment, except that it does not include the compression step of S20 in FIG. 3.

Referring to FIG. 5, the configuration of a shoulder portion 116 of the pressure vessel produced by the manufacturing method of the comparative example is described. In FIG. 5, a liner layer 120 before the heat treatment step is shown as a dashed line, and the liner layer 120 after the heat treatment step is shown as a solid line.

As described above, in the reinforcement layer formation step in the comparative example, the semi-finished product is not compressed in the axial direction. Therefore, the shape of the liner layer 120 before the heat treatment step is the same as that of the liner layer 20 before the compression step in the embodiment (dashed line portion in FIG. 4). In the manufacturing method of the comparative example, the reinforced fiber S is wound around the outer surface of the liner layer 120 without compressive force applied thereon (reinforcement layer forming step).

Next, the semi-finished product of the comparative example in which the reinforced fiber S is wound is heated (heat treatment step). The heat in the heat treatment step softens the liner layer 120. Since the liner layer 120 is not distorted in advance, the liner layer 120 at the shoulder portion 116 is displaced inward, as shown in FIG. 5. That is, the liner layer 120 after the heat treatment step is displaced inward in the radial direction relative to the liner layer 120 before the heat treatment step. In this case, a gap is created between the reinforcement layer and the liner layer 120 at the shoulder portion 116. The gap between the reinforcement layer and the liner layer 120 reduces the strength of the pressure vessel. In addition, the shape of the liner layer 120 at the shoulder portion 116 becomes an unintended shape.

As described above, the method of manufacturing the pressure vessel 2 in this embodiment includes: applying the compressive force L along the axial direction to the semi-finished product 40 of the pressure vessel 2 comprising the liner layer 20 (S20 in FIG. 3); forming the reinforcement layer 22 onto the outer surface of the semi-finished product 40 with the compressive force L applied thereon, with the reinforced fiber S impregnated with the curable resin (S30); and curing the resin by heating the semi-finished product 40 comprising the formed reinforcement layer 22 (S40).

According to the above configuration, at the start of the step of curing the resin, the semi-finished product 40 is loaded with the compressive force L. That is, the liner layer 20 of the semi-finished product 40 is distorted. According to this configuration, even if the liner layer 20 softens during the resin curing, the liner layer 20 is suppressed from deforming inward. Therefore, generation of a gap between the liner layer 20 and the reinforcement layer 22 can be suppressed in the pressure vessel 2. Therefore, the strength of the pressure vessel 2 can be improved.

The strength of the shoulder portions 116 of the pressure vessel can be weakened by an unintended change in the shape of the liner layer 120, as in the comparative example pressure vessel. In this case, a means of increasing the number of reinforcement layers at the shoulder portions 116 can be considered to ensure the strength of the shoulder portion 116. According to the above configuration, the shape of the liner layer 20 at the shoulder portions 16 can be shaped as intended. Therefore, it is possible to suppress the weakening of the strength of the shoulder portion 16, and there is no need to increase the number of layers of reinforcement layers at the shoulder portions 16.

In the compression step, the compressive force L is applied so that the liner layer 20 at the shoulder portions 16 is displaced radially outward.

According to the above configuration, generation of a gap between the liner layer 20 and the reinforcement layer 22 at the shoulder portion 16 of the pressure vessel 2 can be suppressed. Therefore, the liner layer 20 can be firmly reinforced by the reinforcement layer 22.

The compression step includes a process of supporting the opposing ends of the semi-finished product 40 in the axial direction and bringing one end of the supported ends in the axial direction closer toward the other end of the supported ends in the axial direction.

According to the above configuration, the compressive force L can be applied to the semi-finished product 40 with a simple configuration.

The embodiments have been described in detail in the above. However, these are only examples and do not limit the claims. The technology described in the claims includes various modifications and changes of the concrete examples represented above.
(First Variation) The compression unit 54 of the manufacturing device 50 may comprise two movable plates and two actuators connected to each of the two movable plates. In this variation, the compression step includes supporting the opposing ends of the semi-finished product 40 in the axial direction and bringing one of the supported ends closer together toward the other of the supported ends.
(Second Variation) In the second variation, the method of winding the reinforced fiber S around the outer surface of the semi-finished product 40 is not limited to the FW method, and another method may be utilized.

The technical elements explained in the present description or drawings exert technical utility independently or in combination of some of them, and the combination is not limited to one described in the claims as filed. Moreover, the technology exemplified in the present description or drawings achieves a plurality of objects at the same time, and has technical utility by achieving one of such objects.

What is claimed is:

1. A method for manufacturing a pressure vessel configured to store a fluid, wherein the pressure vessel comprises a laminated structure comprising a liner layer and a reinforcement layer that are laminated on each another, and a shape of the pressure vessel includes a cylindrical portion extending along an axial direction, and dome portions respectively disposed at opposing ends of the cylindrical portion in the axial direction,
the method comprising:
applying a compressive force along the axial direction to a semi-finished product of the pressure vessel comprising the liner layer;
forming the reinforcement layer onto an outer surface of the semi-finished product with the compressive force applied thereon, with a reinforced fiber impregnated with a curable resin; and
curing the resin by heating the semi-finished product comprising the formed reinforcement layer.

2. The method as in claim 1, wherein, in the applying of the compressive force, the compressive force is applied so that the liner layer at shoulder portions is displaced outward in a radial direction, wherein the shoulder portions are respectively located at boundaries between the cylindrical portion and the dome portions.

3. The method as in claim 1, wherein the applying of the compressive force comprises:
supporting the opposing ends in the axial direction of the semi-finished product; and
bringing at least one end of the supported ends closer to another end of the supported ends.

4. The method as in claim 1, wherein, in the forming of the reinforcement layer, the reinforcement layer is formed by a filament winding method.
